(19) United States
(12) Patent Application Publication
(10) Pub. No.: US 2006/0173820 A1
(43) Pub. Date: Aug. 3, 2006

(54) System and method for generating contextual survey sequence for search results

(75) Inventors: Eddie L. Mays, Renton, WA (US); Oliver Hurst-Hiller, Seattle, WA (US)

Correspondence Address: SHOOK, HARDY & BACON L.L.P.;(c/o MICROSOFT CORPORATION), 2555 GRAND BOULEVARD, KANSAS CITY, MO, 64108-2613, US

(73) Assignee: Microsoft Corporation, Redmond, WA (US)

(21) Appl. No.: 11/044,295

(22) Filed: Jan. 28, 2005

(51) Int. Cl. G06F 7/00

(52) U.S. Cl. 707/3

(57) ABSTRACT

A system and related techniques generate a survey to capture a user's feedback about the quality of search results, in a continuous context with the user's Web page or other search activity. A survey frame inviting the user to undertake a set of search questions may be presented within a set of page frames which display search results. The survey frame enables the user to be prompted into a dialogue to supply feedback about their search experience, while still within the contextual workflow of that experience, and still being able to view or review results or content which they have received. User distraction is therefore minimized while feedback quality may be improved. The user's feedback, which rates the quality or accuracy of the search results or search experience may be stored and used to train search intelligence.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The invention relates to the field of computerized information retrieval, and more particularly to systems and methods for generating and exposing a survey sequence which ranks or rates search results, from within the contextual workflow of the user's search experience.

### BACKGROUND OF THE INVENTION

As Internet and other search technology matures and deepens the ability to collect user feedback about the quality and accuracy of search results and the uses' search experience has become more useful and necessary. Search services or engines may seek to have users answer a questionnaire about the accuracy or quality of the results returned to a user input, to help train search intelligence and assess the overall operation of the service. Search services today may generate a dialogue to present to the user to ask them, for instance, to rate their satisfaction on a numerical or other scale, rate the perceived accuracy in the results or offer other input or feedback. That feedback may be stored to a database for mining, training and other purposes.

However, search questionnaires or dialogues as presently implemented suffer from certain drawbacks or disadvantages, in terms of efficiency and contextual workflow. For example, some search services may present a popup or other invitation to a user to answer a survey about their search results, activation of which however causes another browser window to open to present the questions or rating selections. Separating the questionnaire presentation from the search presentation interrupts the contextual workflow, forces the user to flip back and forth between pages to review results and survey questions, may slow down the user's resumption of search activity and also may lead to less accurate survey feedback, since the user may rush through the response sequence or forget details of the search, since a few seconds or a few minutes of time may be required to complete the survey page.

On the other hand, some search platforms have attempted to gather user feedback through the avenue of specially-modified Web browsers or other applications, which approach may introduce separate difficulties in user adoption and installation, compatibility, versioning and other operational aspects. Other known survey techniques may include transmission of survey questionnaires to a user by email, which however may involve even greater contextual separation and other problems, including that not all search users may wish to share or may have available email addresses. Other problems in search survey technology exist.

### SUMMARY OF THE INVENTION

The invention overcoming these and other problems in the art relates in one regard to a system and method for generating a contextual survey sequence for search results, in which an Internet search or other search user may be presented with a survey to gather feedback about their search experience, inline with the workflow and environment of the user's search activity as or after it occurs. According to embodiments of the invention in one regard, a user who has received a set of search results may also be presented with an integrated survey frame within a Web page which invites the user to enter a survey dialogue, which dialogue is then generated within that same page or environment, with search results or selected pages or other content still displayed or selectable within the page. According to embodiments of the invention in another regard, the survey dialogue or sequence may be generated and presented to the user as an extension to a Web browser toolbar, exposing an invitation to enter a survey sequence from that point. The survey dialogue may then be executed within that toolbar or panel. According to embodiments of the invention in a general regard, the user who chooses to opt in to responding to a search survey may thus experience a comparatively convenient dialogue within the page or environment of their search activity, and with minimal distraction from their search context or workflow. Moreover, because in one regard the users' feedback may be collected contemporaneously, or close to contemporaneously, with their search navigation, the quality or accuracy of the users' responses and details about their search experience may be more faithfully captured. The captured feedback may then be used for training of search intelligence, to use as data for human search rating or review, or other purposes. Individual survey sequences may be presented or represented for individual selected Web sites or other results, or for refined or repeated queries and their overall results.

### BRIEF DESCRIPTION OF THE DRAWINGS

FIG. 1 illustrates an environment in which a system and method for generating a contextual survey sequence for search results may operate, according to embodiments of the invention.

FIG. 2 illustrates a survey sequence which may be generated or presented when a user elects to participate in a survey dialogue related to search, according to embodiments of the invention.

FIG. 3 illustrates a flowchart of overall survey sequence processing, according to embodiments of the invention.

FIG. 4 illustrates an environment in which a system and method for generating a survey sequence for search results may operate, according to further embodiments of the invention.

FIG. 5 illustrates a flowchart of overall survey sequence processing, according to further embodiments of the invention.

### DETAILED DESCRIPTION OF EMBODIMENTS

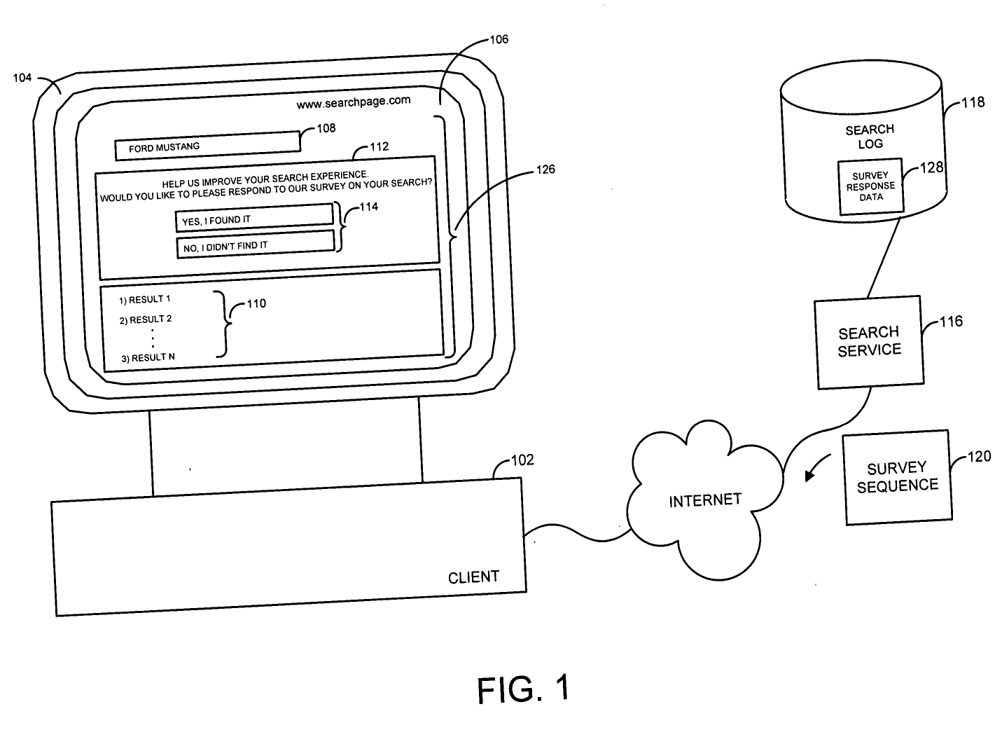

FIG. 1 illustrates an environment in which a system and method for generating a contextual survey sequence for search results may operate, according to an embodiment of the invention. As illustrated in that figure a user may operate a client 102 such as a personal computer, network-enabled cellular telephone, personal digital assistant or other machine or hardware to perform search activity including entering key word or other queries or searches, accessing online or other content and receiving and manipulating search results. More particularly and as shown, a user may operate a client interface 104 such as a graphical user interface, command-line, voice-operated or other interface to enter search input 108, for instance at a Web or other search page 106, or other search site. Search input 108 may include for example one or more words or other alphanumeric, textual or other expressions, and may be transmitted to a search service 116 such as a public search engine or other search resource. The search service 116 may in general return a set of search results 110 to the client 102 or other machine or hardware, for the user to view, select, navigate and manipulate, which results may include for example a list of URLs (universal resource locators) or other addresses or identifiers of Web pages or other documents or content matching or related to the search input 108. According to embodiments of the invention in one regard, the set of search results 110 and other parts of or data constituting the search page 106 may consist of a set of page frames 126, such as hyper text markup language (HTML) frames assembled into a Web page or other documents via a Web browser or other application. According to embodiments of the invention in one regard, each frame in the set of page frames 126 may contain or consist of content drawn from separate URLs or other addresses or locators, assembled into a coherent larger document or page presentation via the Web browser or other tool.

In addition to the delivery of the set of search results 110 themselves, according to embodiments of the invention in one regard the user may also be presented with a survey dialogue or questionnaire containing a series of questions inviting the user to rate the perceived accuracy, relevance, quality and other aspects of the user's search experience. More particularly, according to embodiments of the invention as shown, the user may be presented with a survey frame 112 within the set of pages frames 126, to display an invitation or survey opt-in 114 for the user to initiate the process of answering a survey dialogue or sequence ratings the user's search experience. The survey opt-in 114 and survey frame 112 containing that opt-in dialogue box or other selector may in embodiments be generated and presented by search service 116 upon delivery of the set of search results 110 to the client 102, or generated by other resources or at other times.

According to embodiments of the invention in one regard, the selection or acceptance of the survey opt-in 114 may trigger the generation and presentation of a survey sequence 120 reflecting a set or series of questions regarding the quality, accuracy and other characteristics of the set of survey results 110. According to embodiments of the invention in one regard, the survey sequence may be accessed or generated by search service 116 or other resource, and transmitted to client 102 for presentation in the survey frame 112. In general, user responses to those dialogues or questions may be captured and transmitted to search service 116 as survey response data 128, which may for example be stored in a search log 118 or other database or data store. The survey response data 128 may be used by search service 116 or other resources or operators to train search intelligence, assess overall quality of operations, or for other purposes.

However, according to embodiments of the invention in a general regard, because the survey frame 112 and ensuing survey sequence 120 are presented in a common environment with the set of search results 110 and other search activity, the user may be able to respond to the survey questions or requests for input with a contemporaneous impression of the accuracy or quality of the results. Moreover, because the survey sequence 120 may be presented via survey frame 112, that frame and the survey questions may follow or remain presented to the user as they select and navigate to individual Web sites or other hits within the set of search results 110, without interruption. The survey activity may thus remain in the context of the search activity, in a continuous manner. The survey response data 128 may thus be collected in relation to an individual page or result, multiple pages or results, or the set of search results 110 as a whole. Again, according to embodiments of the invention in a further regard, that survey response data 128 may be collected contemporaneously or close in time to the search activity, further enhancing the quality of that data. Moreover, according to embodiments of the invention in another regard, in part because the survey sequence 120 may be delivered via survey frame 112 which may consist in embodiments of an HTML-compatible, XML (extensible markup language)-compatible or other frame-based or frame-compatible format or layout, survey operations may be carried out via regular Web browsers or other applications, without a need for browsers or other applications which are specially modified for survey or feedback purposes.

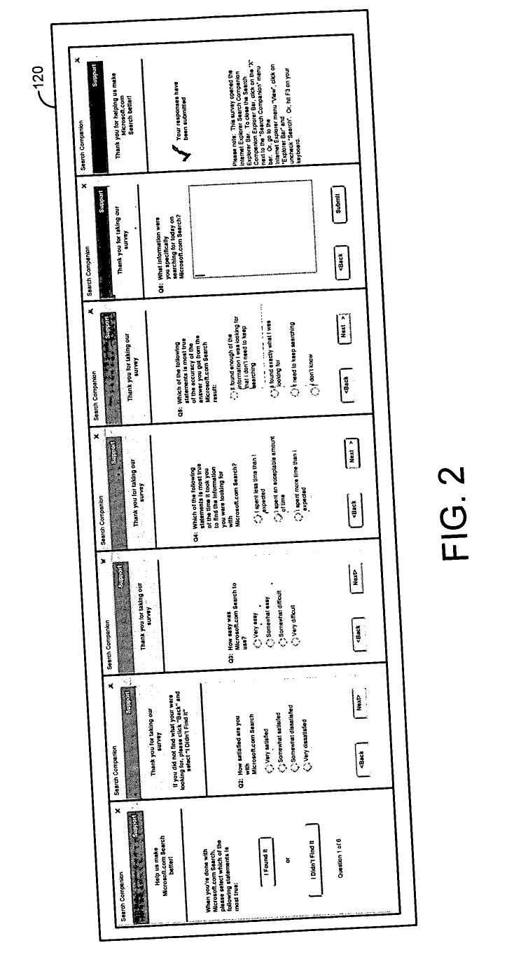

FIG. 2 illustrates a survey sequence 120 including a particular series of questions or invitations for input from a user, according to embodiments of the invention in one regard. In embodiments as shown, after selection of the survey opt-in 114 the user may be presented with a series of questions which as shown may ask the user to select rated, ordinal or ranked answers regarding the user's perceived satisfaction with their search, ease of use of the search service 116, time efficiency in performing the search, accuracy of the search and other performance characteristics. User answers to those queries may for example be converted to numerical values according to the degree of satisfaction or other variable, which may for example be used to tabulate statistics about search results and other operational details of search service 116. In embodiments as shown, the survey sequence 120 may likewise include a dialogue box for textual user response, which may for example be reviewed by human operators at a later time. According to embodiments of the invention in one regard, the survey frame 112 may be refreshed to display one question in survey sequence 120 after the other, or multiple or all questions in survey sequence 120 may be displayed at the same time within survey frame 112. According to embodiments of the invention in a further regard, the questions within survey sequence 120 may be adaptive or conditional, in that those questions may branch through a tree of various logical paths depending on inputs which the user supplies at a given point. Thus survey sequence 120 for a user who selects a response indicating only marginal accuracy in the results may descend into a set of further questions about the possible sources of the perceived inaccuracy, such as possible typographical errors or lack of interpreted relation between search terms. Other survey sequences 120 are possible. It may be noted that in cases where the user declines to accept survey opt-in 114, the survey frame 112 may in embodiments be closed, or may in embodiments be left open to re-present survey opt-in 114 upon initiation of further or later search activity.

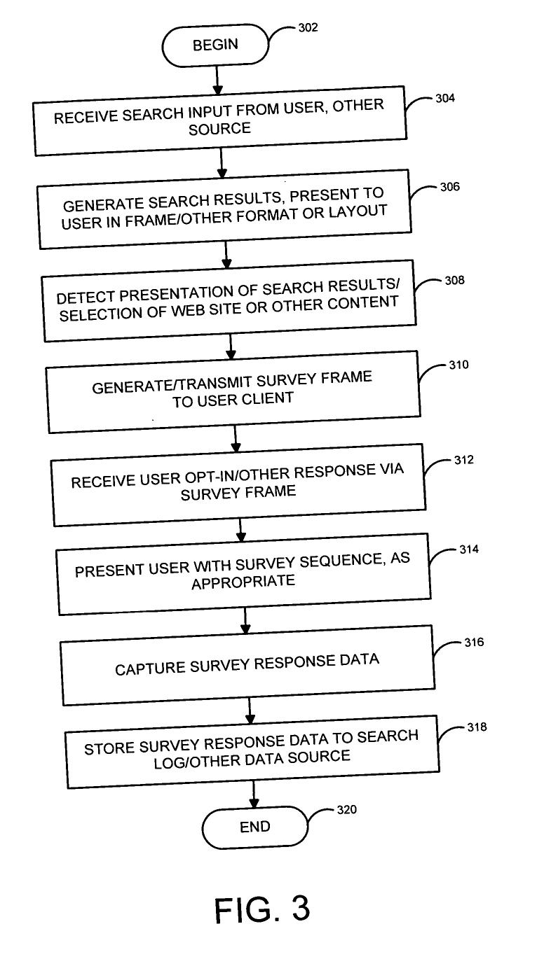

Overall survey processing according to embodiments of the invention in one regard is illustrated in FIG. 3. In step 302, processing may begin. In step 304, a set of search input 108 may be received from a user or other source. In step 306, a set of search results 110 may be generated by search service 116 or other search logic or resources, and presented to the user in a frame-based format such as HTML or other formats, layouts or page descriptors. In step 308, the presentation of the set of search results 110 and/or the selection of a Web site or other content within those results may be detected. In step 310, a survey frame 112 may be generated by search service 116 or other resource and transmitted to a browser or other application operating on client 102 or other destination.

In step 312, the user's survey opt-in 114 or other response may be received by search service 116 or other search logic or resource. In step 314, the user may be presented with a survey sequence 120 such as a sequence of requests or dialogues to rate the quality, accuracy or other characteristics of the set of search results 110 and/or individually selected Web sites or other hits or content. Those ratings may be selectable by number, ordinal or qualitative rankings, or based on other measures, criteria or inputs. Survey sequence 120 may in embodiments include branched lines of questions or other sequences depending on user responses or other factors. In step 316, the resulting survey response data 128 may be captured, for instance by search service 116 or other resource. In step 318, the survey response data 128 may be stored to search log 118 or other data store. In step 320, processing may repeat, return to a prior processing point, jump to a further processing point or end.

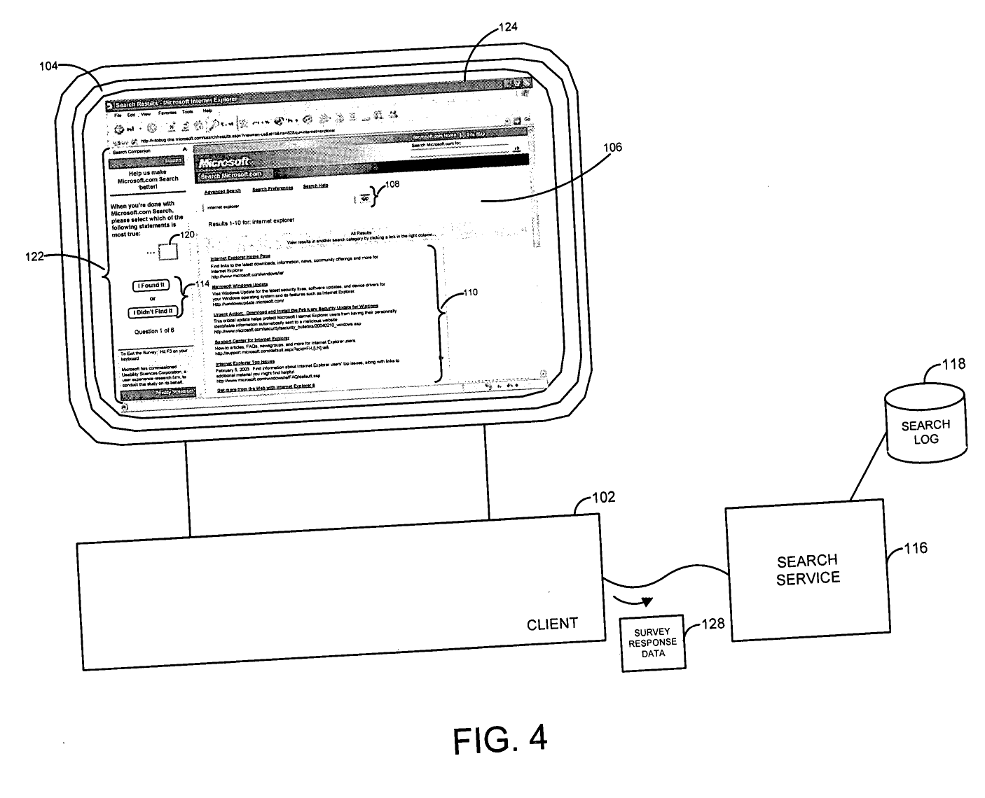

FIG. 4 illustrates an environment in which a system and method for generating a contextual survey sequence for search results may operate, according to a further embodiment of the invention. As illustrated in that figure a user may likewise operate a client 102 such as a personal computer, network-enabled cellular telephone, personal digital assistant or other machine or hardware to perform search activity, including to operate a browser 124 to navigate to a search page 106, and for instance entering key word or other queries or search input 108 and receiving a set of search results 110 from a search service 116 as a result. According to embodiments of the invention as illustrated in that figure, upon delivery of the set of search results 110 or at other times, browser 124 may generate or present to the user a survey toolbar 122 which may prompt the user with a survey opt-in 114, inviting the user to enter feedback, answer questions or supply input related to their search experience. In contrast for example to embodiments of the invention illustrated in FIG. 1, according to embodiments of the invention illustrated in FIG. 4 the survey toolbar 122 may be part of the toolbar and control logic of browser 124 or other application itself, rather than encoded in a frame structure to be presented as part of an HTML or other page rendition. According to embodiments of the invention in this regard, the survey toolbar 122 may likewise display a survey sequence 120 to the user upon selection of survey opt-in 114, from within the structure of that toolbar and related resources but in embodiments not necessarily dependent on search service 116 to receive that sequence or content. Survey toolbar 122 may however capture survey response data 128 as part of the local control logic of browser 124, and transmit that data in the background or otherwise to the search service 116 for storage to search log 118 or other data stores. Survey response data 128 may again be used to train the search logic for search service 116 or other search resource, to assess customer satisfaction or other aspects of search operation. In embodiments of the invention as illustrated in FIG. 4, certain security or administrative advantages may be realized, including increased security of data since data in survey toolbar 122, being embedded in browser 124 or other application, may not be easily viewed by frames in search page 106 or other potentially invasive code. It may be noted that in embodiments, the survey toolbar 122 may be implemented (as shown) to be selectable to be clicked away or terminated, or in embodiments may be implemented as a permanent toolbar feature. As in embodiments illustrated in FIG. 1, the survey sequence 120 presented via survey toolbar 122 may be associated with any one selected search result within the set of search results 110, a group of selected results, or may be associated with or rate the set of search results 110, as a whole. According to embodiments of the invention, in general, therefore the survey sequence 120 may consequently travel, be contextually associated with and be capable of collecting feedback on the user's experience in a continuous fashion, as they navigate various levels of search activity.

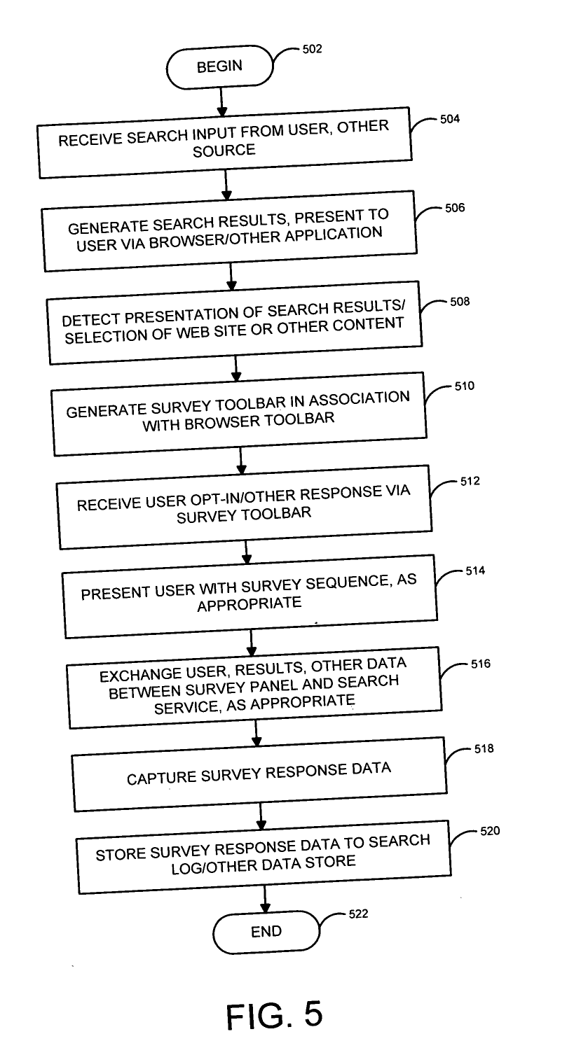

Overall survey processing according to embodiments of the invention in a further regard is illustrated in FIG. 5. In step 502, processing may begin. In step 504, a set of search input 108 may be received from a user or other source. In step 506, a set of search results 110 may be generated by search service 116 or other search logic or resources, and presented to the user in a frame or other format via browser 124 or other application. In step 508, the presentation of the set of search results 110 and/or the selection of a Web site or other content within those results may be detected. In step 510, a survey toolbar 122 may be generated and presented as part of, an extension to or in association with the toolbar resources of browser 124 or other application.

In step 512, the user's survey opt-in 114 or other response may be recognized and received by survey toolbar 122 or other logic or resource. In step 514, the user may be presented with a survey sequence 120 within survey toolbar 122, such as a sequence of requests or dialogues to rate the quality, accuracy or other characteristics of the set of search results 110 and/or individually selected Web sites or other hits or content. Those ratings may likewise be selectable by number, ordinal or qualitative rankings, or based on other measures, criteria or inputs. Survey sequence 120 may in embodiments likewise include branched series or lines of questions or other sequences depending on user responses or other factors.

In step 516, data related to the user, the set of search results 110, user selection paths and other data related to the search activity may be exchanged by the survey toolbar 122 with search service 116 or other resource, as appropriate. In step 518, the survey response data 128 generated in the user session may be captured, for instance by survey toolbar 122 and/or search service 116 or other resource. In step 520, the survey response data 128 may be stored to search log 118 or other data store. In step 522, processing may repeat, return to a prior processing point, jump to a further processing point or end.

The foregoing description of the invention is illustrative, and modifications in configuration and implementation will occur to persons skilled in the art. For instance, while the invention in embodiments has generally been described in terms of search activity executed by way of an Internet-based search service 114, in embodiments the search resources may include other public or private, online or offline search services or portals, such as search within intranets or privately held databases. In embodiments the search function may also be performed on a desktop basis, for instance to search a user's hard drive or other storage on client 102 for files or other content, or on other clients or machines.

Similarly, while the invention has in embodiments been described as involving search activity conducted through a browser 124, in embodiments other applications, utilities, tools or resources may be used or employed in search functions. Likewise, while the invention has in general been described as involving the rating or ranking of information retrieval services, in embodiments the invention may be used to generate contextual surveys within the environments of other activities as well.

Furthermore, while in embodiments the search service 116, search log 118 and other resources have generally been described as hosted or executed in a single site or resource, in embodiments that and other logic and functions may be deployed in a distributed manner over multiple machines, storage or other resources. Other hardware, software or other resources described as singular may in embodiments be distributed, and similarly in embodiments resources described as distributed may be combined. The scope of the invention is accordingly intended to be limited only by the following claims.

We claim:

1. A system for presenting a survey sequence associated with search results, comprising:
a set of search results, the set of search results being generated in response to user input; and
a survey interface, the survey interface presenting a survey sequence related to the set of search results in a common environment with the set of search results.

2. A system according to claim 1, wherein the common environment comprises a page comprising a set of frames.

3. A system according to claim 2, wherein the survey sequence is presented within at least one survey frame in the page.

4. A system according to claim 3, wherein the page comprises a Web page.

5. A system according to claim 1, wherein the survey sequence comprises a series of questions rating the sufficiency of the set of search results.

6. A system according to claim 1, wherein the set of search results are generated by a networked search service.

7. A system according to claim 1, wherein responses to the survey sequence are stored as survey response data.

8. A method for presenting a survey sequence associated with search results, comprising:
receiving a set of search results generated in response to user input; and
presenting a survey sequence via a survey interface related to the set of search results in a common environment with the set of search results.

9. A method according to claim 8, wherein the common environment comprises a page comprising a set of frames.

10. A method according to claim 9, wherein the survey sequence is presented within at least one survey frame in the page.

11. A method according to claim 10, wherein the page comprises a Web page.

12. A method according to claim 8, wherein the survey sequence comprises a series of questions rating the sufficiency of the set of search results.

13. A method according to claim 8, wherein the set of search results are generated by a networked search service.

14. A method according to claim 8, further comprising storing responses to the survey sequence are stored as survey response data.

15. A survey sequence associated with search results, the survey sequence being generated by a method comprising:
receiving a set of search results generated in response to user input; and
presenting a survey sequence via a survey interface related to the set of search results in a common environment with the set of search results.

16. A survey sequence according to claim 15, wherein the common environment comprises a page comprising a set of frames.

17. A survey sequence according to claim 16, wherein the survey sequence is presented within at least one survey frame in the page.

18. A survey sequence according to claim 17, wherein the page comprises a Web page.

19. A survey sequence according to claim 15, wherein the survey sequence comprises a series of questions rating the sufficiency of the set of search results.

20. A survey sequence according to claim 15, wherein the set of search results are generated by a networked search service.
